(19) United States
(12) Patent Application Publication
(10) Pub. No.: US 2011/0084590 A1
(43) Pub. Date: Apr. 14, 2011

(54) ELECTRON-EMITTING DEVICE, ELECTRON BEAM APPARATUS AND IMAGE DISPLAY APPARATUS

(75) Inventors: Hideyasu Tashiro, Yokohama-shi (JP); Yohei Hashizume, Machida-shi (JP); Taro Hiroike, Yamato-shi (JP); Fumikazu Kobayashi, Zama-shi (JP)

(73) Assignee: CANON KABUSHIKI KAISHA, Tokyo (JP)

(21) Appl. No.: 12/897,338

(22) Filed: Oct. 4, 2010

(30) Foreign Application Priority Data
Oct. 8, 2009 (JP) 2009-234523

(51) Int. Cl. H01J 1/02

(52) U.S. Cl. 313/310

(57) ABSTRACT

An electron-emitting device according to the present invention, comprises: an insulating member having a top face, a side face and a recess portion formed between the top face and the side face; a cathode electrode which is disposed on the side face and has an electron emitting portion located in a boundary portion between the side face and the recess portion; and a gate electrode which is disposed on the top face and of which an edge faces the electron emitting portion, wherein the boundary portion in which the electron emitting portion is located has concavity and convexity in a direction parallel to the top face.

### BACKGROUND OF THE INVENTION

1. Field of the Invention

The present invention relates to an electron-emitting device, an electron beam apparatus and an image display apparatus.

2. Description of the Related Art

In an image display apparatus using an electron beam apparatus, reduction of power consumption is demanded as the display apparatus becomes larger and resolution increases. In order to reduce power consumption, capacity (electrostatic capacity) of the electron-emitting device is reduced, and the current that flows into the drive circuit during driving (charge and discharge current) is reduced.

An example of the electron-emitting device is a device having a configuration disclosed in Japanese Patent Application Laid-Open No. 2001-167693. In concrete terms, Japanese Patent Application Laid-Open No. 2001-167693 discloses an electron-emitting device comprising an insulating member, a cathode electrode which is disposed on the side face of the insulating member and has an electron emitting portion at the edge, and a gate electrode which is disposed on the top face of the insulating member and of which an edge faces the electron emitting portion.

The capacity of the electron-emitting device is in proportion to the area of the gate electrode and cathode electrode facing each other via the insulating member. In the case of the electron-emitting device according to Japanese Patent Application Laid-Open No. 2001-167693 (configuration shown in FIG. 9), the capacity of the electron-emitting device can be reduced by decreasing the length T of the gate electrode 3 and the cathode electrode 4 in the Y direction in FIG. 9. However if the widths of the gate electrode 3 and the cathode electrode 4 are decreased, length L of the electron emitting portion decreases, which decreases the electron emission amount of the electron-emitting device.

### SUMMARY OF THE INVENTION

The present invention provides an electron-emitting device of which decrease of the electron emission amount is controlled and the electrostatic capacity is decreased, and an electron beam apparatus and image display apparatus which have this electron-emitting device.

An electron-emitting device according to the present invention, comprises:

an insulating member having a top face, a side face and a recess portion formed between the top face and the side face;

a cathode electrode which is disposed on the side face and has an electron emitting portion located in a boundary portion between the side face and the recess portion; and

a gate electrode which is disposed on the top face and of which an edge faces the electron emitting portion, wherein

the boundary portion in which the electron emitting portion is located has concavity and convexity in a direction parallel to the top face.

An electron beam apparatus according to the present invention, comprises:

the electron-emitting device according to the present invention; and

an anode electrode which is disposed so as to face the electron emitting portion via the gate electrode.

An image display apparatus according to the present invention, comprises:

the electron beam apparatus according to the present invention; and

a substrate having the anode electrode and a light emitting member which emits lights by electrons emitted from the electron beam apparatus.

According to the present invention, an electron-emitting device of which decrease of electron emission amount is controlled and electrostatic capacity is decreased, and an electron beam apparatus and image display apparatus, which have this electron-emitting device, can be provided.

Further features of the present invention will become apparent from the following description of exemplary embodiments with reference to the attached drawings.

### BRIEF DESCRIPTION OF THE DRAWINGS

FIGS. 1A to 1C are diagrams depicting a configuration of an electron-emitting device according to the present embodiment;

FIG. 2 is a diagram depicting a configuration of an image display apparatus according to the present embodiment;

FIGS. 3A to 3C are diagram depicting a fabrication steps of the electron-emitting device according to the present embodiment;

FIG. 4 is a diagram depicting a method for forming a cathode electrode of the electron-emitting device according to the present embodiment;

FIG. 5 is a diagram depicting the configuration of the image display apparatus according to the present embodiment;

FIGS. 6A and 6B are diagrams depicting the configuration of the electron-emitting device according to the present embodiment;

FIG. 7 is a diagram depicting a preferred embodiment of the cathode electrode;

FIGS. 8A and 8B are graphs depicting the relationship of the entering amount x and the electron emission amount; and

FIG. 9 is a diagram depicting a configuration of an electron-emitting device according to a comparison example.

### DESCRIPTION OF THE EMBODIMENTS

### <Electron-Emitting Device and Electron Beam Apparatus>

### (Configuration)

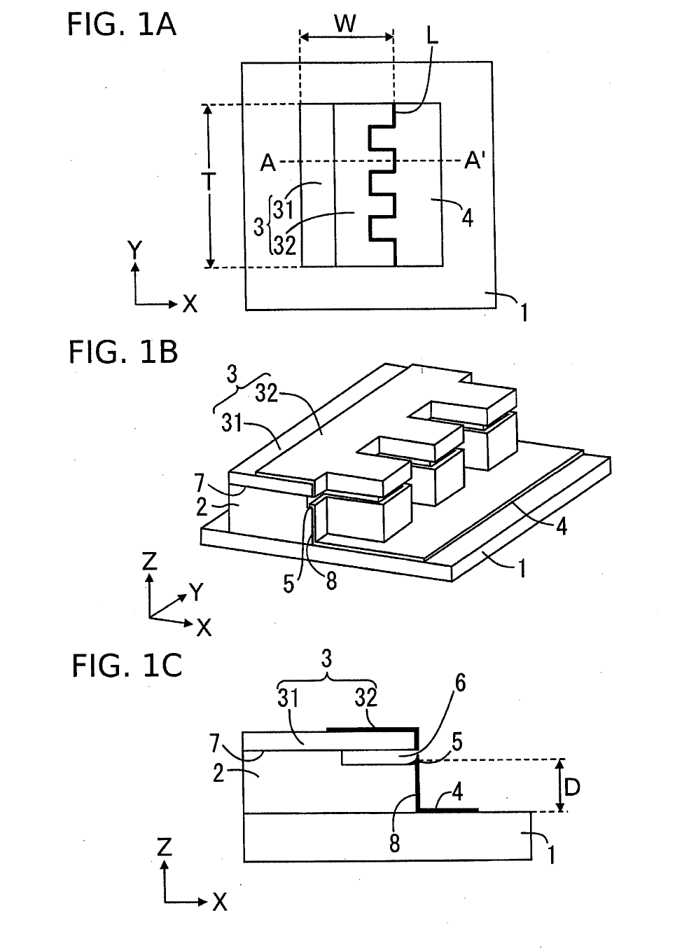

An electron-emitting device according to an embodiment of the present invention will now be described. FIGS. 1A to 1C are diagrams depicting a configuration of the electron-emitting device according to the present embodiment. In concrete terms, FIG. 1A is a top view of the electron-emitting device (viewed in the Z direction), FIG. 1B is a perspective view thereof, and FIG. 1C is a cross-sectional view sectioned at A-A′ of FIG. 1A. As FIGS. 1A to 1C show, the electron-emitting device according to the present embodiment has an insulating member 2, a gate electrode 3 and a cathode electrode 4. In the present embodiment, the electron-emitting device is formed on a substrate 1.

For the substrate 1, an insulating substrate, such as quartz glass, glass in which the inclusion amount of such impurities as Na is decreased, soda-lime glass, laminated plate of SiO₂ layered on a soda-lime glass and Si substrate by a sputtering method, or such ceramics as alumina can be used.

The insulating member 2 has a top face 7, side face 8, and a recess portion 6 formed between the top face 7 and the side face 8. For the material of the insulating member 2, insulating material having excellent processability, such as SiO₂ and Si₃N₄, is used. The insulating member 2 can be formed by depositing the insulating material on the substrate 1 by a general method, such as a sputtering method and a CVD method, and then performing patterning using photolithography or the like.

The cathode electrode 4 is disposed on the side face of the insulating member 2 (on the side face 8). The cathode electrode 4 has an electron emitting portion 5, which is located in the boundary portion between the side face 8 and the recess portion 6.

The gate electrode 3 is disposed on the top face of the insulating member 2 (on the top face 7). The edge of the gate electrode 3 faces the electron emitting portion 5.

For the gate electrode 3 and the cathode electrode 4, conductive metal formed by a general vacuum film deposition technology, such as a CVD method, evaporation method and sputtering method, is used. For the material, an appropriate material is selected out of metal, alloy, carbide, boride, nitride, semiconductor, organic polymer, amorphous carbon, graphite, diamond-like carbon, carbon in which diamond is dispersed, and carbon compound, for example. For the metal, Be, Mg, Ti, Zr, Hf, V, Nb, Ta, Mo, W, Al, Cu, Ni, Cr, Au, Pt and Pd can be used, and for the alloy, an alloy generated using these metals can be used. For the carbide, TiC, ZrC, HfC, TaC, SiC, WC or the like can be used, for the boride, HfB₂, ZrB₂, LaB₆, CeB₆, YB₄, GbB₄ or the like can be used, for the nitride, TaN, TiN, ZrN, HfN or the like can be used, and for the semiconductor, Si, Ge or the like can be used. The thickness of the gate electrode 3 and the cathode electrode 4 (lengths in the Z direction) are designed to be appropriate values. The gate electrode 3 and the cathode electrode 4 are connected to a feed line from a power supply, which is not illustrated, respectively. The feed line, gate electrode 3 and cathode electrode 4 may be formed together.

In FIGS. 1A to 1C, the symbol T denotes the length of the gate electrode 3 and the cathode electrode 4 in the Y direction. The symbol W denotes the length of the gate electrode 3 in the X direction, and the symbol D denotes the length of the cathode electrode 4 in the Z direction. The symbol L denotes the length of the area at which the gate electrode 3 and the cathode electrode 4 (electron emitting portion 5) are facing (electron emitting portion length).

According to the present embodiment, as shown in FIG. 1A, the insulating member 2 has concavity and convexity in the direction parallel to the top face 7 in the boundary portion where the electron emitting portion 5 is located, therefore the electrostatic capacity can be reduced while suppressing a decrease of the electron emission amount. This will be described in detail.

The electrostatic capacity of the electron-emitting device is generated by the electric charges stored between the electrodes which face each other via the insulating member 2. In the electron-emitting device according to the present embodiment, electric charges are stored between the insulating member 2 and the recess portion 6 which exist between the gate electrode 3 and the cathode electrode 4, so an electrostatic capacity is generated. In this case, the electrostatic capacity is in proportion to the area where the gate electrode 3 and the cathode electrode 4 face each other via the insulating member 2. The area of the gate electrode 3 is determined by the length T and the length W. The area of the cathode electrode 4 is determined by the length T and the length D.

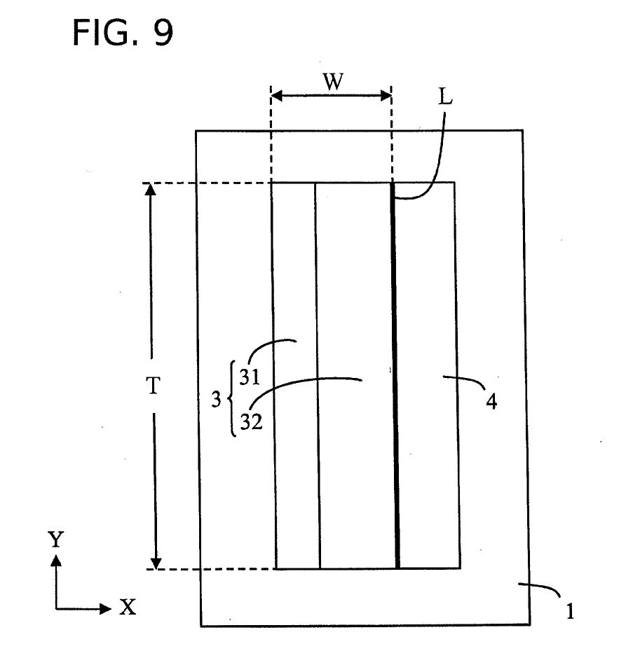

According to the present embodiment, the insulating member 2 has the above mentioned concavity and convexity (electron emitting portion 5 is disposed along the concavity and convexity), so the length T can be decreased while maintaining the length of the electron emitting portion (electron emitting portion length). As a result, a decrease of the electron emission amount, which occurs if the length T is decreased in the configuration in FIG. 9, can be suppressed, and the area between the gate electrode 3 and the cathode electrode 4, which face via the insulating member 2, can be decreased (in other words, the electrostatic capacity can be decreased).

By disposing an anode electrode, which faces the electron emitting portion 5 via the gate electrode 3, an electron beam apparatus that implements the above effect can be constructed. The anode electrode is an electrode for accelerating the electrons emitted from the electron-emitting device, and high voltage is applied to this anode electrode.

The concavity and convexity are not limited to the comb type concavity and convexity shown in FIG. 1A. The concavity and convexity may be saw-tooth type concavity and convexity, or wave type concavity and convexity. Unless the electron emitting portion 5 is not disposed in a straight line in the Y direction, any type of concavity and convexity can be used.

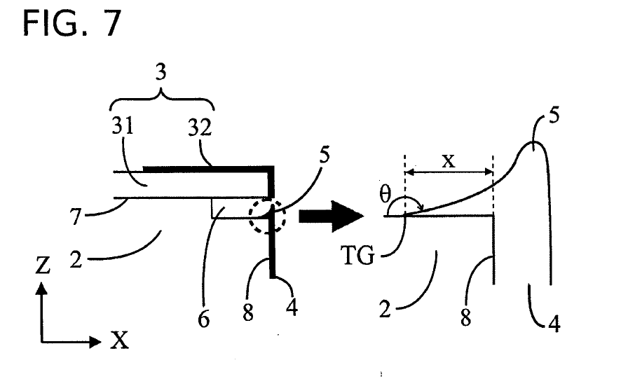

As FIG. 7 shows, it is preferable that the cathode electrode 4 covers from the side face 8 to the part of the inner face of the recess portion 6 via the boundary portion, and the electron emitting portion 5 protrudes toward the gate electrode 3.

In concrete terms, the following are three merits if the cathode electrode 4 entering the inner face of the recess portion 6.
1. Mechanical adhesion strength of the cathode electrode 4 and the insulating member 2 increases since the contact area thereof increases (increase of adhesion strength).
2. The heat generated in the electron emitting portion 5 can be efficiently released to the insulating member 2 since the thermal contact area of the cathode electrode 4 and the insulating member 2 increases (decrease of thermal resistance).
3. Field intensity at the triple point generated in the insulating layer—vacuum—metal interface can be decreased since the edge of the cathode electrode 4 is disposed inside the recess portion 6. As a result, the discharge phenomena, due to abnormal field generation, can be prevented.

Protrusion of the electron emitting portion 5 toward the gate electrode 3 makes it easier for the electric field to concentrate at the tip of the electron emitting portion 5, and electrons can be emitted more efficiently.

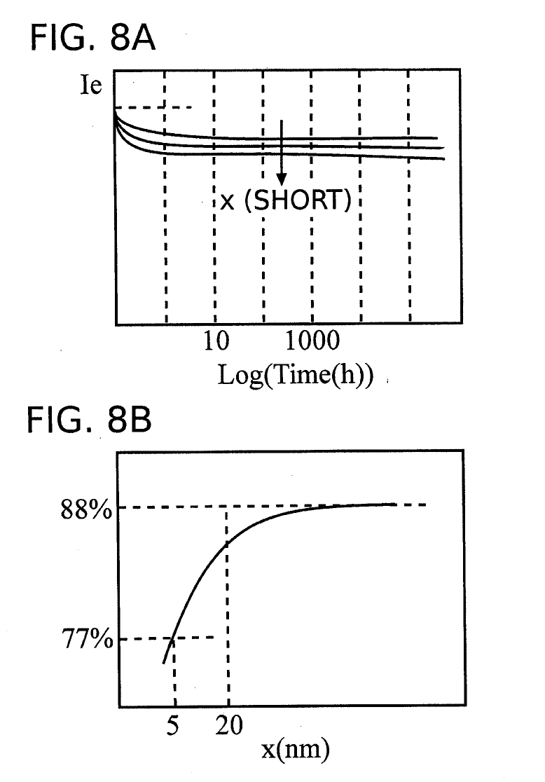

The second merit will be described in detail. FIG. 8A is a graph depicting the dependence of the electron emission current Ie on time when the entering amount x of the cathode electrode 4 which enters into the inner surface of the recess portion 6 is changed. The electron emission current Ie corresponds to the electron emission amount, and refers to the current that flows due to the electrons that reach the anode electrode, out of the electrons emitted from the electron emitting portion 5. In FIG. 8A, the electron emission current Ie, normalized with an initial value that is an average value of the electron emission current Ie detected during the first 10 seconds after the start of driving the electron-emitting device, is plotted with the abscissa (time) as a common logarithm. As FIG. 8A shows, the electron emission current Ie (electron emission amount) drops more dramatically as the entering amount x becomes shorter.

FIG. 8B is a graph depicting the electron emission current Ie (electron emission current Ie when the initial value is regarded as 100%) at one hour after starting the driving of the electron-emitting device, with respect to the entering amount x. As FIG. 8B shows, the electron emission current Ie drops more dramatically as the entering amount x becomes shorter, just like FIG. 8A. If the entering amount x is longer than 20 nm, the electron emission current Ie does not drop very much.

According to the above results, it is likely that increasing the entering amount x increases the contact area of the insulating member 2 and the cathode electrode 4, which decreases the thermal resistance between these members. As a result, an increase in temperature at the tip of the electron emitting portion 5 is suppressed, and a drop in the electron emission current Ie (electron emission amount) is suppressed. Increasing the entering amount x also increases the volume of the cathode electrode 4 (that is, the thermal capacity of the cathode electrode 4 increases), and an increase in the temperature at the tip of the electron emitting portion 5 is suppressed.

The entering amount x is preferably longer than 20 nm, but this does not mean the longer the better. If the entering amount x is too long, the leak current that flows between the cathode electrode 4 and the gate electrode 3 (leak current via the inner surface of the recess portion 6) increases, therefore the electron emission amount decreases. The entering amount x is controlled depending on the size of the recess portion 6 of the insulating member 2 (e.g. thickness of the later mentioned insulating layer 22), the thickness of the gate electrode 3, and the direction in which the electron emitting portion 5 protrudes (depositing direction when the cathode electrode 4 is formed (deposited)). Normally the entering amount x is set to about 10 to 30 nm, preferably 20 nm or more, 30 nm or less.

Now the triple point will be described. A point where three types of materials, having different dielectric constants, such as vacuum, insulating material and metal, contact with each other is normally called a “triple point”. In the case of the example in FIG. 7, the point indicated by “TG” is the triple point. At the triple point, the electric field may become much higher than the peripheral area thereof depending on the conditions, and a discharge may be generated. In the case of FIG. 7, the triple point is located inside the recess portion 6, so the field intensity at the triple point can be weakened.

If the contact angle (θ in FIG. 7), between the cathode electrode 4 and the insulating member 2 (inner surface of the recess portion 6), is 90° or more, the difference between the electric field at the triple point and the electric field in the peripheral area thereof decreases, so it is preferable that the contact angle θ is 90°or more.

### (Manufacturing Method)

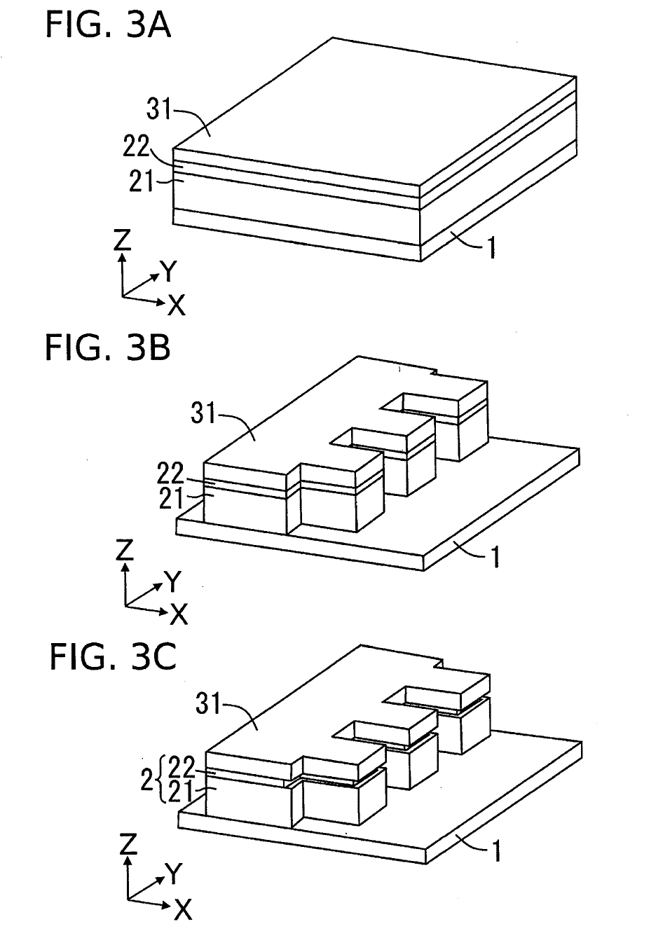

A method for manufacturing the electron-emitting device according to the present embodiment will now be described with reference to FIGS. 3A to 3C.

First the insulating layers 21 and 22 are sequentially deposited on the substrate 1 by a general vacuum film deposition method, (e.g. a sputtering method), a CVD method, a vacuum evaporation method or the like, and the conductive member 31 is deposited thereon by a general vacuum film deposition method (e.g. sputtering method), and a vacuum evaporation method or the like (FIG. 3A).

Then using photolithography technology, the layered body of the insulating layers 21 and 22 and the conductive member 31 are patterned, so as to form the concavity and convexity on the side face of the layered body in a direction parallel to the substrate surface of the substrate 1. For example, photoresist is spin coated, and is then exposed and developed with a mask pattern. By removing a part of the layered body using wet etching or dry etching, identical concavity and convexity are formed in the insulating layers 21 and 22 and conductive member 31 (FIG. 3B). In this step, it is preferable to form a smooth etching surface, and select an etching method according to the material of the respective layer.

Then the side face (face on which concavity and convexity are formed) of the insulating layer 22 is etched back from the insulating layer 21 and conductive member 31 by etching (FIG. 3C). Thereby the insulating member 2 (insulating member constituted by the insulating layers 21 and 22), having the recess portion 6, is formed.

For example, SiN (SiₓN_{y}) is selected for a material of the insulating layer 21, SiO₂ is selected for a material of the insulating layer 22, and TaN is selected for a material of the conductive member 31. Then etching is performed using buffered hydrofluoric acid (BHF) as the etchant. Thereby the insulating layer 22 is selectively etched, and only the side face of the insulating layer 22 can be etched back (recess portion 6 can be formed). The recess portion 6 may be formed together in the above mentioned step of forming the concavity and convexity.

Then the conductive member 32 and the cathode electrode 4 (cathode electrode 4 having the electron emitting portion 5 in the boundary portion of the side face 8 and the recess portion 6) are formed by depositing the conductive thin film on a part of the surfaces of the insulating member 2 and the conductive member 31. By this, the gate electrode 3, which is constituted by the conductive members 31 and 32 and of which an edge is facing the electron emitting portion 5, is formed.

The conductive member 32 and the cathode electrode 4 can be formed by depositing conductive thin film by such a method as sputtering and deposition, and then performing patterning using photolithography technology.

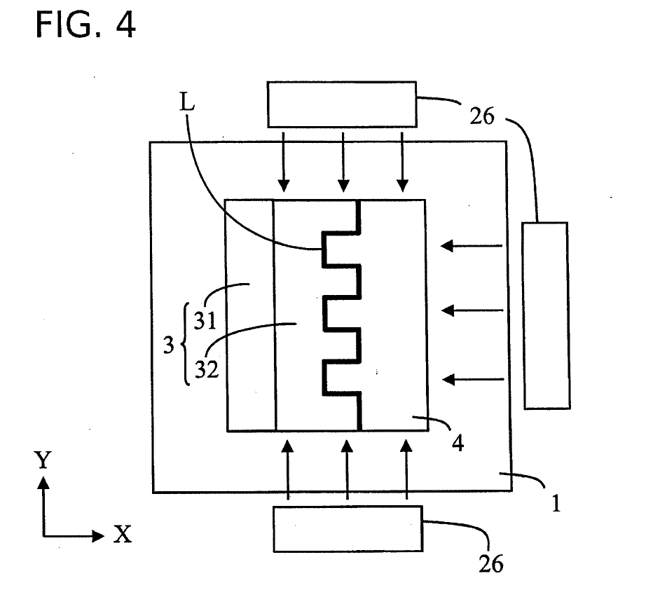

For example, as shown in FIG. 4, in the fixed film deposition and non-directional sputtering film deposition (collimationless sputtering film deposition), the target 26 is disposed on three faces in the X direction, +Y direction and −Y direction, and the film is evenly deposited from the three directions. As a result, the conductive member 32 and the cathode electrode 4, having the same film thickness throughout the entire face of the concavity and convexity, can be formed. The conductive member 32 and the cathode electrode 4 may be formed by disposing the target on one surface, and depositing film while changing the orientation of the electron-emitting device (so that the film is deposited in the X direction +Y direction and −Y direction).

At this time, according to the present embodiment, the conductive member 32 (gate electrode 3) and the cathode electrode 4 are parted, since the recess portion 6 is formed. As a result, a micro-space is automatically formed between the cathode electrode 4 and the edge of the gate electrode 3 at the boundary portion of the side face 8 of the insulating member 2 and the recess portion 6 (the electron emitting portion 5 is formed at the boundary portion of the side face 8 of the insulating member 2 and the recess portion 6, and the edge of the gate electrode 3 faces the electron emitting portion 5).

To make the shape of the electron emitting portion 5 to be optimum for extracting electrons, and to allow the cathode electrode 4 to enter into the inner surface of the recess portion 6, the angle (direction) of deposition, film deposition time and temperature and degree of vacuum during film formation must be controlled.

Through the above steps, the electron-emitting device shown in FIG. 1B can be fabricated.

The gate electrode 3 and the cathode electrode 4 are connected to the feeder line from the power supply, which is not illustrated, respectively, and a predetermined voltage is applied between the gate electrode 3 and the cathode electrode 4. Thereby a high electric field is generated in the electron emitting portion 5 (specifically the above mentioned micro-space), and electrons are emitted from the cathode electrode 4 (electron emitting portion 5).

Because of the presence of the recess portion 6, not only the above mentioned micro-space can be automatically formed, but also the creeping distance between the gate electrode 3 and the cathode electrode 4 can be increased. By increasing this creeping distance, the leak current that flows between the gate electrode 3 and the cathode electrode 4, when driving the electron beam apparatus, can be decreased, and electron emitting efficiency can be improved (electron emission amount that reaches the anode can be increased).

The larger the size of the recess portion 6 (etched back amount of the insulating layer 22) the better, since the leak current decreasing effect increases. But if the size of the recess portion 6 is too large, the gate electrode 3 located on the recess portion 6 may be deformed or destroyed. The size of the recess portion 6 is appropriately set considering these aspects.

### <Image Display Apparatus>

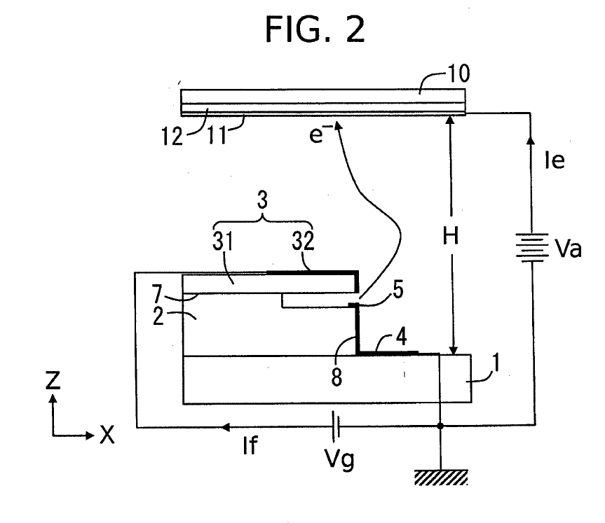

An image display apparatus according to the present embodiment will be described. FIG. 2 is a diagram depicting a configuration of the image display apparatus using the electron beam apparatus according to the present embodiment, and is a cross-sectional view similar to FIG. 1C.

The image display apparatus according to the present embodiment has the above mentioned electron beam apparatus, and a face plate (substrate) having an anode electrode 11 and a light emitting member 12. In the example in FIG. 2, the face plate also has a substrate 10.

The anode electrode 11 is disposed so as to face an electron emitting portion 5 via a gate electrode 3, and accelerates the electrons emitted from the electron-emitting device. In the example in FIG. 2, the anode electrode 11 is distant from the substrate 1 by distance H in the Z direction.

The light emitting member 12 emits lights by the electrons emitted from the electron beam apparatus. For example, the light emitting member 12 is disposed on the surface of the anode electrode 11, that is at the opposite side of the gate electrode. Electrons emitted from the electron beam apparatus are accelerated by the anode electrode 11, and collide with the light emitting member 12. Thereby the light emitting member 12 emits lights, and an image is formed.

In FIG. 2, Vg denotes the voltage applied between the gate electrode 3 and the cathode electrode 4. If denotes a device current that flows when Vg is applied (the current generated by electrons which are directly emitted from the cathode electrode to the gate electrode, without passing through the inner surface of the insulating member; the current flowing between the gate electrode and the cathode electrode, from which leak current is eliminated). Va denotes voltage applied between the cathode electrode 4 and the anode electrode 11. Ie denotes the electron emission current that flows between the electron-emitting device and the anode electrode 11 (the current that flows by the electrons, emitted from the electron-emitting device, reaching the anode electrode 11).

The image display apparatus, according to the present embodiment, may have a plurality of electron-emitting devices. Normally in such an image display apparatus, a plurality of electron-emitting devices are disposed in a matrix in the X direction and Y direction. For wiring the electron-emitting devices, a simple matrix wiring can be used. In the case of a simple matrix wiring, a wiring in the X direction is commonly connected either to the cathode electrodes 4 or the gate electrodes 3 of the plurality of electron-emitting devices disposed in a same row, and a wiring in the Y direction is commonly connected to the other of the gate electrodes 3 and the cathode electrodes 4 of the electron-emitting devices disposed in a same column.

In the electron-emitting device according to the present embodiment, electrons are emitted by applying voltage, higher than the threshold voltage, between the gate electrode 3 and the cathode electrode 4. The amount of electrons to be emitted is controlled by the wave height value and the pulse width of the pulsed voltage that is applied between electrodes. On the other hand, electrons are hardly emitted if a voltage, less than the threshold voltage, is applied. By applying pulsed signals (scan signal and modulation signal) to the wiring in the X direction (X direction wiring) and the wiring in the Y direction (Y direction wiring) respectively, a device which emits electrons can be selected, and the electron emission amount can be controlled.

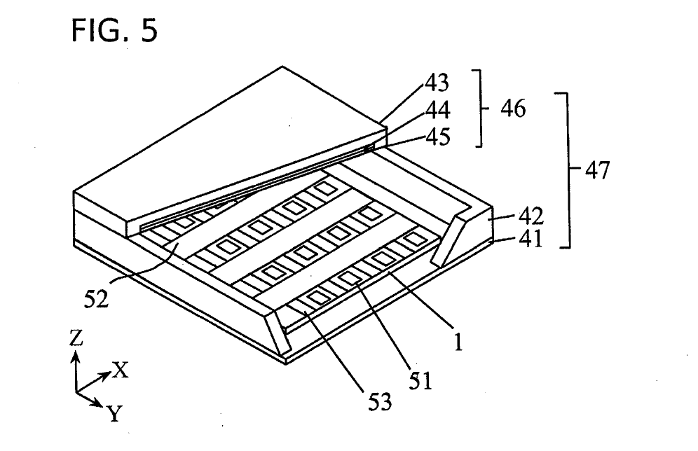

Now the image display apparatus having a plurality of electron-emitting devices, which are wired in a simple matrix, will be described in detail with reference to FIG. 5. FIG. 5 is a diagram depicting an example of a display panel of the image display apparatus having a plurality of electron-emitting devices according to the present embodiment.

In FIG. 5, the reference numeral 1 denotes a substrate on which a plurality of electron-emitting devices are disposed (corresponds to the substrate 1 in FIGS. 1A to 1C), and the reference numeral 41 denotes a rear plate for securing the substrate 1.

The reference numeral 46 denotes a substrate (face plate) having a metal back 45 as the anode electrode 11 and a phosphor film 44 as the light emitting member 12. In the example in FIG. 5, the face plate 46 further has a glass substrate 43 (corresponds to the substrate 10 in FIG. 2), and the phosphor film 44 and the metal back 45 and the like are formed on the inner face of the glass substrate 43.

The reference numeral 42 denotes a support frame and the rear plate 41 and the face plate 46 are connected to the support frame 42 by a sealing member, such as frit glass. The support frame 42, the rear plate 41 and the face plate 46 are sealed by baking the frit glass in air or in nitrogen for 10 minutes or more at a 400° C. to 500° C. temperature range. The reference numeral 47 denotes an envelope constituted by the support frame 42, rear plate 41 and face plate 46.

The reference numeral 51 denotes the electron-emitting device according to the present embodiment, and the reference numerals 52 and 53 denote the X direction wiring and the Y direction wiring (feeder line) connected to the gate electrode 3 and the cathode electrode 4 of the electron-emitting device 51 respectively.

The rear plate 41 is disposed mainly for the purpose of reinforcing the strength of the substrate 1, so if the substrate 1 has a sufficient strength, the support frame 42 may be directly connected to the substrate 1, so that the face plate 46 support frame 42 and the substrate 1 constitute the envelope 47. If necessary, a support material called a “spacer”, which is not illustrated, may be disposed between the face plate 46 and the rear plate 41, whereby an envelope 47 having sufficient resistance to atmospheric pressure is constructed.

The present invention is not limited to the above mentioned embodiments, but each composing element may be replaced with a substitute element or equivalent element, only if the object of the present invention can be achieved.

### EXAMPLES

Examples of the present invention will now be described. The present invention is not limited to the following examples described below.

### Example 1

### [Fabrication of Electron-Emitting Device]

An electron-emitting device according to Example 1 has a configuration shown in FIGS. 1A to 1C. This configuration will be described below in detail.

First PD 200, which is a low sodium glass, developed for plasma displays, is well cleaned as the substrate 1, and the insulating layer 21, insulating layer 22 and conductive member 31 are sequentially layered on the substrate 1 (FIG. 3A). In concrete terms, a 500 nm thick SiN (SiₓN_{y}) film is formed by a sputtering method as the insulating layer 21. A 20 nm thick SiO₂ film is formed by a sputtering method as the insulating layer 22. A 50 nm thick TaN film is formed by a sputtering method as the conductive member 31.

Then a positive type photoresist (TSMR-98/made by Tokyo Ohka Kogyo Co., Ltd.) is spin coated, and is then exposed and developed with a photo mask pattern. Thereby a resist pattern, having the concavity and convexity in a direction parallel to the substrate surface (X direction in FIG. 1A) of the substrate 1, is formed on the conductive member 31. Then a part of the conductive member 31, insulating layer 22 and the insulating layer 21 are removed together by dry etching (reactive ion etching: RIE). At this time, CF₄ gas is used as the processing gas, since materials to generate fluoride are selected, for the conductive member 31 and the insulating layers 22 and 21, as mentioned above. As a result, as shown in FIG. 3B, the concavity and convexity in a direction parallel to the substrate surface (XY plane) of the substrate 1 are formed on the side face of the layered body constituted by the conductive member 31, insulating layer 22 and insulating layer 21. In concrete terms, the length of the concave portion and the convex portion in the X direction is 2 μm, the length thereof in the Y direction is 2 μm, the length T is 330 μm, the length W is 8.5 μm, and the length of the electron emitting portion L is 658 μm. The angle formed by the substrate surface and the side face is about 80°.

Then the resist pattern is peeled, and the side face of the insulating layer 22 is etched back about 70 nm from the insulating layer 21 and the conductive member 31 by etching using BHF (LAL 100/Stella Chemifa Corp.), as shown in FIG. 3C. Thereby the insulating member 2, having the recess portion 6, is formed.

Next a lift off pattern is formed with photoresist, and Cu film is formed by a sputtering method. Then patterning is performed by lift off, and the feeder lines (X direction wiring, Y direction wiring) from the power supply, which is not illustrated, are formed.

Then as FIG. 4 shows, the conductive member 32 and the cathode electrode 4 are formed by performing fixed film deposition and non-directional EB deposition (collimationless sputter film deposition). In this case, the conductive member 32 and the cathode electrode 4 are formed to be connected to the feeder lines (X direction wiring, Y direction wiring) respectively. In concrete terms, argon plasma is generated for two minutes with a 0.1 Pa degree of vacuum at a temperature of 300 K. At this time, the target 26 is disposed in three faces, that is, the X direction, +Y direction and −Y direction, at a 60° angle with respect to the substrate surface (XY plane). For these three directions, a uniform 20 nm thick Mo film is deposited. Then the resist pattern is formed by exposing and developing photo resist (TSMR-98/made by Tokyo Ohka Kogyo Co., Ltd.) with a photo mask pattern. Using this photo resist pattern as a mask, the Mo film is dry-etched by CF₄ gas, and as a result, the gate electrode 3 and the cathode electrode 4, which are connected to the X direction wiring and the Y direction wiring respectively, are formed.

Through the above steps, the electron-emitting device is fabricated.

### Evaluation result of Example 1

The anode electrode 11 is disposed above the fabricated electron-emitting device, and the capacity, device current If and the electron emission current Ie of the electron-emitting device are measured. In concrete terms, the anode electrode 11 is disposed at the position which is distant by distance H=1.6 mm (in the Z direction) from the substrate 1. The potential of the Y direction wiring (gate electrode 3) is 10 V, the potential of the X direction wiring (cathode electrode 4) is −10 V, and the potential of the anode electrode 11 is 10 kV. As a result, the electrostatic capacity of the electron-emitting device is 0.074 pF, the device current If is 97 μA, and the electron emission current Ie is 4.9 μA.

### Comparison Example

### [Fabrication of Electron-Emitting Device]

The electron-emitting device according to the comparison example has the configuration shown in FIG. 9. The electron-emitting device according to this comparison example has a same configuration as Example 1, except that the electron emitting portion 5 is disposed in a straight line in the Y direction in FIG. 9. In concrete terms, a resist pattern is formed and the insulating member 2 and the conductive member 31 are processed by dry etching, so that the length L of the electron emitting portion is 658 μm, the length T is 658 μm, and the length W is 8.5 μm in the step of forming the concavity and convexity in Example 1. Description of the steps other than this step, which are the same as Example 1, is omitted.

### Evaluation Result of Comparison Example

The anode electrode 11 is disposed above the fabricated electron-emitting device, and the capacity of the electron-emitting device, device current If and electron emission current Ie are measured under the same conditions as Example 1. As a result, the electrostatic capacity of the electron-emitting device is 0.078 pF, the device current If is 97 μA, and the electron emission current Ie is 4.9 μA.

### [Fabrication of Image Display Apparatus]

An image display apparatus A, having a plurality of electron-emitting devices of Example 1, is fabricated as shown in FIG. 5.

First the face plate 46 is sealed in a vacuum at 2 mm above the rear plate 41 via the support frame 42, to form the envelope 47. Two spacers (not illustrated), of which thickness is 2 mm and width is 200 μm, are disposed between the rear plate 41 and the face plate 46, so as to withstand the atmospheric pressure. Inside the envelope 47, a getter (not illustrated), to maintain the high degree of vacuum inside the envelope 47, is disposed. Indium is used to bond the rear plate 41, support frame 42 and face plate 46.

In the same manner, an image display apparatus B, having a plurality of electron-emitting devices of the comparison example, is fabricated.

### [Result of Comparing Image Display Apparatuses]

Voltage is applied between the gate electrode 3 and the cathode electrode 4 via each wiring, and high voltage is applied to the metal back 45 of the face plate 46 via the high voltage terminal, whereby images are displayed on the fabricated image display apparatuses A and B respectively. In concrete terms, the potential of the signal wiring (Y direction wiring 53; gate electrode 3) is 0 to +10 V, the potential of the scan wiring (X direction wiring 52; cathode electrode 4) is 0 to −10 V, and the potential of the metal back 45 is 5 to 10 kV. Under these driving conditions, the image display apparatuses A and B are driven, and the static capacity (total value) and the electron emission current Ie (total value) of the plurality of electron-emitting devices are measured and compared.

As a result, the electron emission current Ie is the same for the image display apparatus A having a plurality of electron-emitting devices of Example 1, and the image display apparatus B having a plurality of electron-emitting devices of the comparison example. The electrostatic capacity of the image display apparatus A is decreased to 95% when the electrostatic capacity of the image display apparatus B is regarded to be 100%. Accordingly, the power consumption of the image display apparatus A is decreased compared with the image display apparatus B.

### Example 2

### [Fabrication of Electron-Emitting Device and Image Display Apparatus]

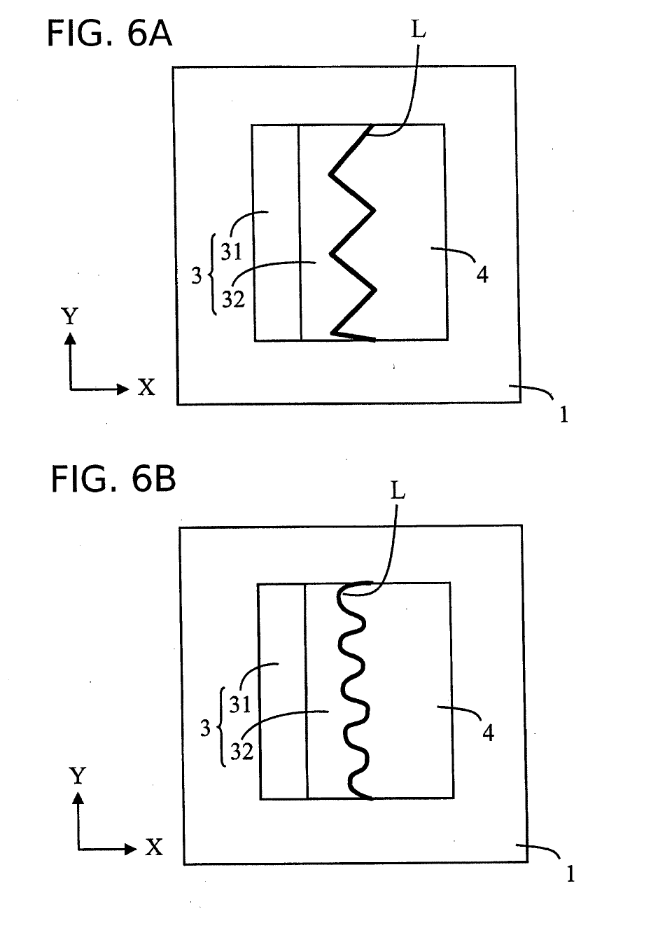

As electron-emitting devices according to Example 2, an electron-emitting device having the configuration in FIG. 6A and an electron-emitting device having the configuration in FIG. 6B are fabricated. Then an image display apparatus C, having a plurality of electron-emitting devices in FIG. 6A, and an image display apparatus D, having a plurality of electron-emitting devices in FIG. 6B, are fabricated. The electron-emitting devices according to this example have the same configuration as Example 1, except that the concavity and convexity have a saw tooth shape (FIG. 6A) and wave shape (FIG. 6B). The configuration of the image display apparatus having these devices is the same as that of the above mentioned image display apparatus having the electron-emitting devices in Example 1.

A method for manufacturing the electron-emitting device having saw tooth shaped concavity and convexity will be described.

In this example, a resist pattern is formed so that triangular wave shaped concavity and convexity, of which length of one side is 2 μm and angle formed by adjacent sides is 60°, is repeated on the XY plane, in the step of forming concavity and convexity in Example 1. Then the insulating member 2 and the conductive member 31 are processed by dry etching, so as to form the concavity and convexity (saw tooth shaped concavity and convexity) in the X direction on the side face of the layered body constituted by the insulating member 2 and the conductive member 31. The length T is 329 μm, the length W is 8.5 μm and the length L of the electron emitting portion is 658 μm.

Description on the steps other than this step, which is the same as Example 1, is omitted.

A method for manufacturing the electron-emitting device having wave shaped concavity and convexity will be described next.

In this example, a resist pattern is formed so that a semicircle (a semicircle of which diameter is 3 μm or the XY plane), of which length in the X direction is 1.5 μm and the length in the Y direction is 3 μm, is repeated in a wave like manner in the step of forming the concavity and convexity in Example 1. Then the insulating member 2 and the conductive member 31 are processed by dry etching, so as to form the concavity and convexity (wave shaped concavity and convexity) in the X direction on the side face of the layered body constituted by the insulating member 2 and the conductive member 31. The length T is 419 μm, the length W is 8.5 μm and the length L of the electron emitting portion is 658 μm.

Description on the steps other than this step, which is the same as Example 1, is omitted.

### [Evaluation Result]

The image display apparatuses C and D of this example are driven under the same driving conditions as the driving conditions used for comparing the Example 1 and the comparison example, and the electrostatic capacity and the electron emission current Ie are measured for the plurality of electron-emitting devices.

As a result, the electron emission current Ie is the same for the image display apparatuses C and D having a plurality of electron-emitting devices of Example 2, and the image display apparatus B having a plurality of electron-emitting devices of the comparison example. The electrostatic capacity of the image display apparatus C is decreased down to 87% of the image display apparatus B, and the electrostatic capacity of the image display apparatus D is decreased down to 93% thereof. Accordingly the power consumption of the image display apparatuses C and D is also decreased compared with the image display apparatus B.

As described above, according to the configuration of the present embodiment, concavity and convexity are formed in the boundary portion where the electron emitting portion is located (boundary portion between the side face of the insulating member and the recess portion) in the direction parallel to the top face of the insulating member. Therefore the widths of the gate electrode and the cathode electrode (length in the Y direction in FIG. 1A) can be decreased without decreasing the length of the electron emitting portion. In other words, a decrease of the electron emission amount can be suppressed, and the electrostatic capacity of the electron-emitting device can be decreased.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-234523, filed on Oct. 8, 2009, which is hereby incorporated by reference herein in its entirety.

What is claimed is:

1. An electron-emitting device, comprising:
an insulating member having a top face, a side face and a recess portion formed between the top face and the side face;
a cathode electrode which is disposed on the side face and has an electron emitting portion located in a boundary portion between the side face and the recess portion; and
a gate electrode which is disposed on the top face and of which an edge faces the electron emitting portion, wherein
the boundary portion in which the electron emitting portion is located has concavity and convexity in a direction parallel to the top face.

2. The electron-emitting device according to claim 1, wherein
the cathode electrode covers an area from the side face via the boundary portion to a part of an inner face of the recess portion, and
the electron emitting portion protrudes toward the gate electrode.

3. An electron beam apparatus, comprising:
the electron-emitting device according to claims 1; and
an anode electrode which is disposed so as to face the electron emitting portion via the gate electrode.

4. An image display apparatus, comprising:
the electron beam apparatus according to claim 3; and
a substrate having the anode electrode and a light emitting member which emits lights by electrons emitted from the electron beam apparatus.

5. An electron-emitting device, comprising:
an insulating member having a top face, a side face and a recess portion formed between the top face and the side face;
a cathode electrode which is disposed on the side face and has an electron emitting portion, which is part of the cathode electrode, located in a boundary portion between the side face and the recess portion; and
a gate electrode which is disposed on the top face and of which an edge faces the electron emitting portion, wherein
the boundary portion in which the electron emitting portion is located has concavity and convexity in a plane parallel to the top face.
